(19) United States
(12) Patent Application Publication
(10) Pub. No.: US 2025/0192471 A1
(43) Pub. Date: Jun. 12, 2025

(54) ELECTRICAL CONNECTOR AND METHOD OF MAKING THE SAME

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: TENG HUANG, Shenzhen (CN); De-Jin Chen, Shenzhen (CN); He Chen, Zhengzhou (CN); Qing-Tao Ye, Shenzhen (CN)

(21) Appl. No.: 18/975,547

(22) Filed: Dec. 10, 2024

(30) Foreign Application Priority Data
Dec. 11, 2023 (CN) 202311694674.1
Dec. 11, 2023 (CN) 202311695779.9

(51) Int. Cl. H01R 13/52; H01R 13/24; H01R 13/502; H01R 13/639; H01R 101/00

(52) U.S. Cl. CPC H01R 13/5202; H01R 13/2414; H01R 13/502; H01R 13/639; H01R 2101/00

(57) ABSTRACT

An electrical connector includes: a main shell having a receiving cavity going through a front end and a rear end thereof; a conductive assembly received in the receiving cavity and comprising an inner conductor, an outer conductor, and a cable electrically connected with the inner conductor and the outer conductor; and a limiting member; wherein the main shell has plural elastic arms extending rearward in the receiving cavity and each elastic arm has a hook, the conductive assembly has a fixing member radiating therearound, the hooks abut forwards against a rear face of the fixing member, and the limiting member is sandwiched between the elastic arms and an inside of the receiving cavity.

### BACKGROUND OF THE INVENTION

### Field of the Invention

The present invention relates to an electrical connector with an improved waterproof structure.

### Description of Related Arts

China Patent No. 219892473 discloses an electrical connector which includes a main shell with a receiving cavity, four terminal assemblies and a pair of terminal position assurances (TPA). The main shell has two opening slots at opposite sides thereof, each of the terminal position assurances is inserted into the opening slots and extends into the receiving cavity of the main shell to fix two said terminal assemblies. Due to the opening slots of the main shell, the electrical connector has a poor waterproof performance.

Therefore, it is necessary to provide an electrical connector with an improved waterproof structure.

### SUMMARY OF THE INVENTION

The object of the present invention is to provide an electrical connector with an improved waterproof structure.

To achieve the above object, an electrical connector comprises: a main shell having a receiving cavity going through a front end and a rear end thereof; a conductive assembly received in the receiving cavity and comprising an inner conductor, an outer conductor, and a cable electrically connected with the inner conductor and the outer conductor; and a limiting member; wherein the main shell has plural elastic arms extending rearward in the receiving cavity and each elastic arm has a hook, the conductive assembly has a fixing member radiating therearound, the hooks abut forwards against a rear face of the fixing member, and the limiting member is sandwiched between the elastic arms and an inside of the receiving cavity.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector assembly of a first embodiment of this present invention;

FIG. 2 is a cross-sectional view of the electrical connector taken along line A-A in FIG. 1;

FIG. 3 is a cross-sectional view of the electrical connector taken along line B-B in FIG. 1;

FIG. 4 is a cross-sectional view of the electrical connector taken along line C-C in FIG. 1;

FIG. 5 is a perspective view of a main shell of the electrical connector in FIG. 1;

FIG. 6 is an exploded perspective view of the electrical connector in FIG. 1, wherein the main shell and a second locking member are removed;

FIG. 7 is an exploded perspective view of the conductive assembly in FIG. 6;

FIG. 8 is a further exploded perspective view of the conductive assembly in FIG. 7, wherein the fixing member is removed;

FIG. 9 is a cross-sectional view of a mating electrical connector along line D-D of FIG. 1;

FIG. 10 is an exploded perspective view of the mating electrical connector of FIG. 1;

FIG. 11 is an exploded perspective view of a conductive assembly without the fixing member in FIG. 10;

FIG. 12 is a perspective view of an electrical connector of a second embodiment of this present invention;

FIG. 13 is a cross-sectional view of the electrical connector taken along line E-E in FIG. 12;

FIG. 14 is a cross-sectional view of the electrical connector taken along line F-F in FIG. 12; and

FIG. 15 is an exploded perspective view of the conductive assembly and a limiting member of FIG. 12.

### DETAILED DESCRIPTION OF THE PREFERRED EMBODIMENT

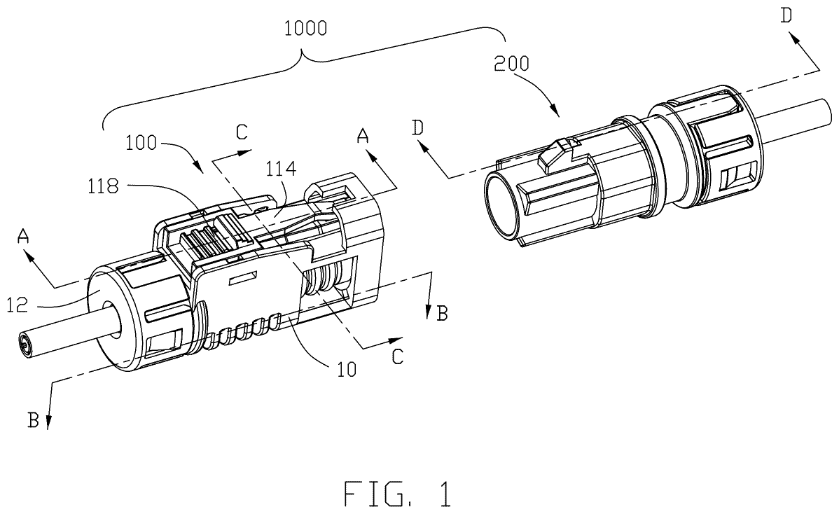

Referring to FIGS. 1-4, an electrical connector assembly 1000 of the first embodiment is illustrated. The electrical connector assembly 1000 comprises an electrical connector 100 or a first electrical connector and a mating connector 200 or a second electrical connector, which transmits high frequency signals when the electrical connector 100 and the mating connector 200 are mated with each other. The electrical connector 100 and the mating connector 200 can be tightly locked to each other by locking members thereof.

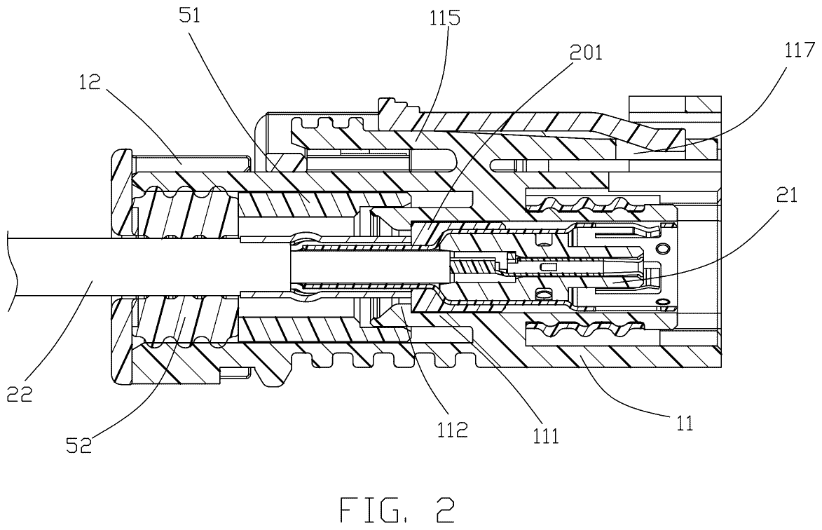

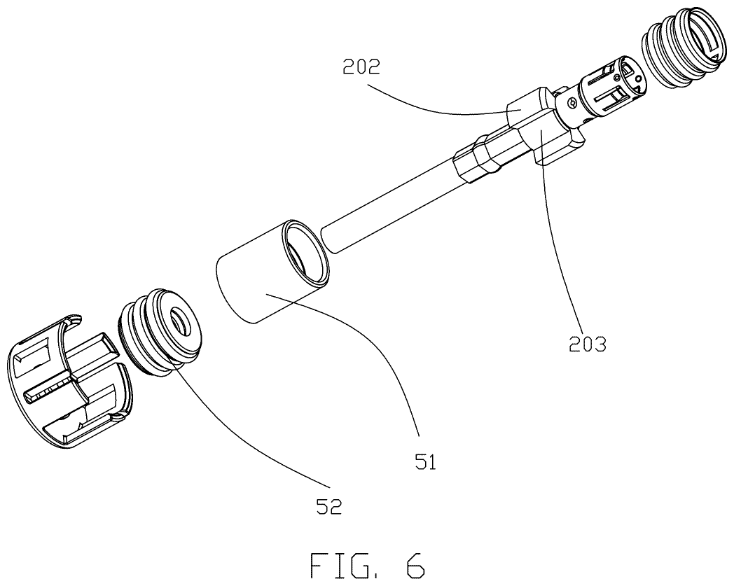

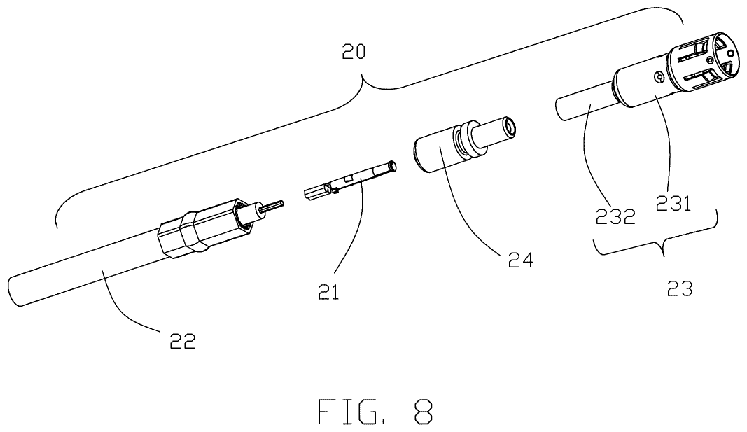

Referring to FIGS. 2-3 and FIG. 8, the electrical connector 100 comprises a shell 10 made from insulating material and an conductive assembly 20 retained in the shell 10, the conductive assembly 20 comprises an inner conductor 21 and a cable 22 electrically connected with a rear end of the inner conductor 21. The inner conductor 21 is configured as a female terminal with a mating hole, the shell 10 comprises a main shell 11 and a rear cover 12, the main shell 11 is configured as a hollow tube and has a receiving cavity 110 going through the main shell 11 along a front and rear direction, so the main shell 11 has two openings at two opposite ends of the receiving cavity 110. One of the two openings is a front opening and the other is a rear opening. The main shell 11 has plural elastic arms 111 extending backward from an inside of the receiving cavity 110, the elastic arm 111 has a rear resisting portion 112. The conductive assembly 20 is assembled into the receiving cavity 110 from the rear opening of the main shell 11 and the conductive assembly 20 has a fixing member 201 as clearly shown in FIG. 6. The resisting portion 112 of the elastic arms 111 resists forwardly against the fixing member 201 to prevent the conductive assembly 20 from moving backward. Preferably, the resisting portion 112 is located behind the fixing member 201 and resists against a back face of the fixing member 201, thus, the fixing member 201 and the conductive assembly 20 can't move backward. The electrical connector 100 comprises a limiting member 51 which is sandwiched between the elastic arms 111 and the inside of the receiving cavity 110 to stop the elastic arms 111 from deforming, thus, the resisting portion 112 would not separate from the limiting member 51.

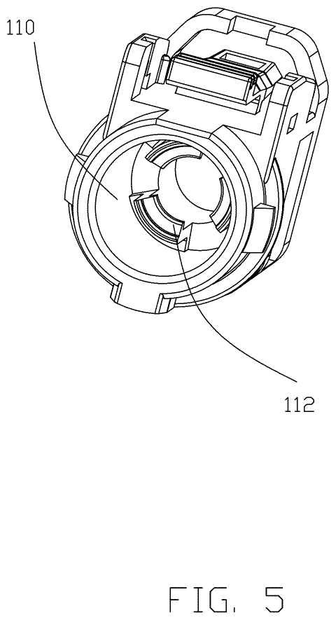

Referring to FIG. 5, in this embodiment, the resisting portion 112 is configured as a hook at a free end of the elastic arm 111. The fixing member 201 is injection molded outside the conductive assembly 20. The hook resists against a rear face of the fixing member 201 of conductive assembly 20 forwardly after the conductive assembly 20 is assembled into the receiving cavity 110 from the rear opening of the main shell 11. Referring to FIGS. 6-8, the conductive assembly 20 further comprises an outer conductor 23, an insulator 24 located between the inner conductor 21 and the outer conductor 23, and the cable 22 is electrically connected to rear ends of both the inner conductor 21 and the outer conductor 23. The fixing member 201 is injection molded outside the outer conductor 23. Alternatively, the fixing member 201 can be fixed with other parts of the conductive assembly 20 in other ways.

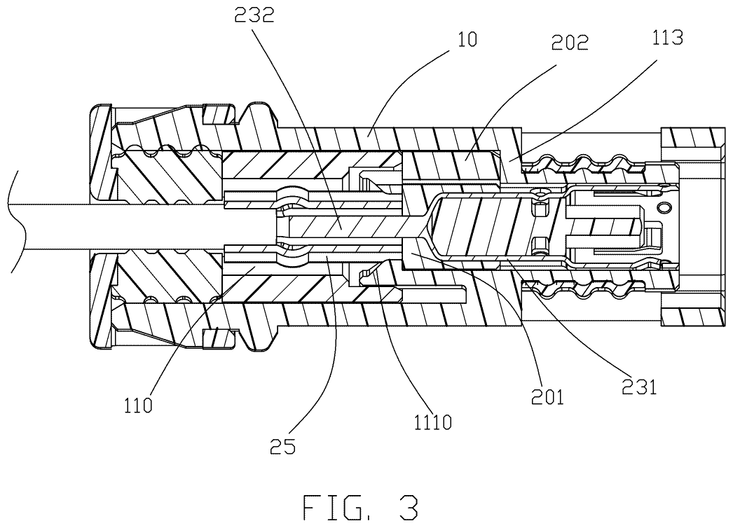

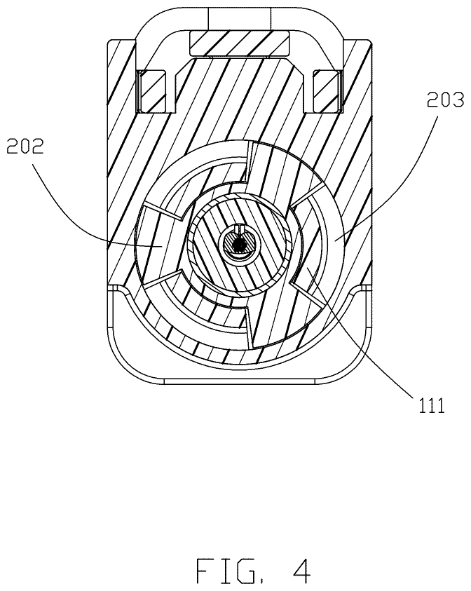

Referring to FIGS. 3-4, the fixing member 201 has plural receiving grooves 203 and plural convex strips 202 between every two receiving grooves 203 along a circumferential direction. The elastic arm 111 goes through the receiving grooves 203 backward until the hook resist against the rear face of the fixing member 201. The convex strips 202 protrude radially until the convex strips 202 reach the inner wall of the receiving cavity 110, thus, the conductive assembly 20 can be retained stably in the receiving cavity 110 along radial direction. The main shell 11 comprises a front abutting portion 113 in front of the convex strips 202 and a front end of the convex strip 202 abuts against the front abutting portion 113, thus, the conductive assembly 20 is prevented from moving forward. To make the conductive assembly 20 fixed by the elastic arms 111 more stable, the number of the elastic arms 111 is not less than two. Preferably, the number of the elastic arms 111 is three.

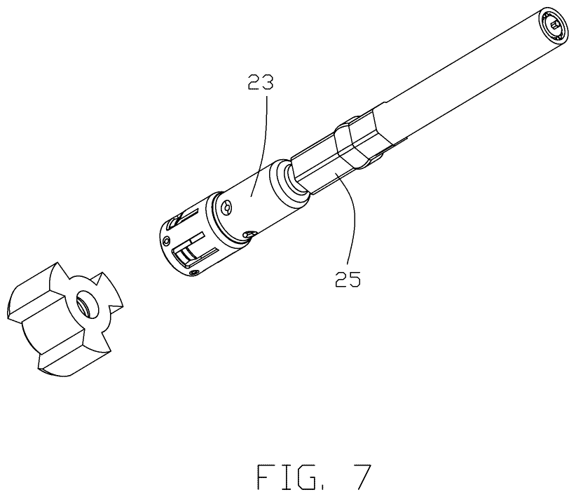

Referring to FIGS. 2-3 and FIG. 8, to make the fixing member 201 firmly fixed outside the outer conductor 23, the outer conductor 23 comprises a front portion 231 and a rear portion 232, a front end of the cable 22 are electrically connected to the rear portion 232 of the outer conductor, a diameter of the front portion 231 is larger than the diameter of the rear portion 232, and the fixing member 201 is injection molded at a junction of the front portion 231 and the rear portion 232. A metal sleeve 25 as shown in FIG. 7 is sleeved outside the front end of the cable 22, and a front end of the metal sleeve 25 abuts against a rear end of the fixing member 201. A rear sealing ring 52 is sleeved outside the cable 22 and located in the receiving cavity 110, and a front end of the rear sealing ring 52 abuts against the limiting member 51 and a rear end of the rear sealing ring 52 abuts against the rear cover 12. A locking assembly 114 as shown in FIGS. 1-2 is disposed at an outer of the main shell 11, which comprises an elastic locking arm 115 extending forwardly from an upper face of the main shell 11 and a second locking member 116. The second locking member 116 is movably installed on the main shell 11. The locking arm 115 has a locking hole 117 at a free end thereof.

Referring to FIG. 3, an assembling method of the electrical connector is described. Firstly, insert the conductive assembly 20 into the receiving cavity 110 of main shell 11 from the rear end of the main shell 11, to facilitate the installation of the conductive assembly 20, the hook of the elastic arms 111 has a guide face 1110, thus, the elastic arms 111 expand outward under the action of the conductive assembly 20. The elastic arms 111 are deformed to move outward firstly with the insertion of the conductive assembly 20, and then, the elastic arms 111 elastically reset after the conductive assembly 20 is installed in place and the hook abuts against the rear face of the fixing member 201, and at this time, front ends of the convex strips 202 of the fixing member 201 abut against the front abutting portion 113. Secondly, insert the limiting member 51 which is configured as a hollow cylinder into the receiving cavity 110 from the rear end of the main shell 11, and the wall of the limiting member 51 is sandwiched between the elastic arms 111 and the inside of the receiving cavity 110 to prevent the elastic arms 111 from deforming. Thirdly, insert the rear sealing ring 52, through which the cable 22 goes, into the receiving cavity 110 from the rear end of the main shell 11 until the front end of the rear sealing ring 52 abuts against the limiting member 51. Fourth, fix the rear cover 12 to the main shell 11.

Referring to FIG. 1 and FIGS. 9-11, similar to the electrical connector 100, the mating connector 200 comprises a shell 40, a conductive assembly 60 and a limiting member 71. The conductive assembly 60 comprises an inner conductor 61, a cable 62, an outer conductor 63 and an insulator 64. The inner conductor 61 is a pin-shaped male terminal, the cable 62 is electrically connected with the inner conductor 61 and the outer conductor 63. It is noted that the words like “front”, “rear”, “behind” etc. are just used for convenient description, and should not be understood as a limitation of the present invention. For each connector, the end where the cables 22, 62 extend is a rear end, and a mating end opposite to rear end is a front end.

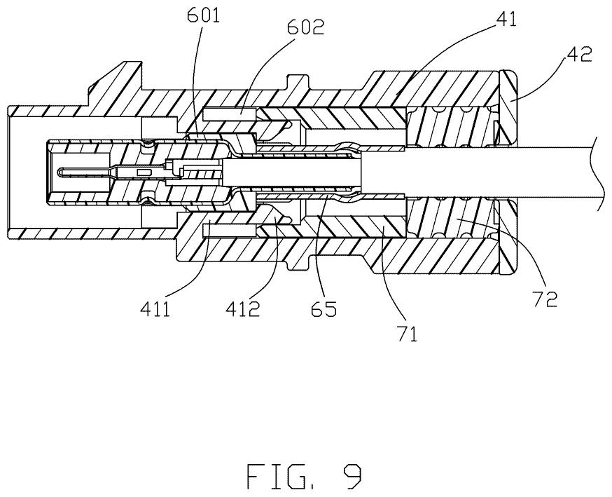

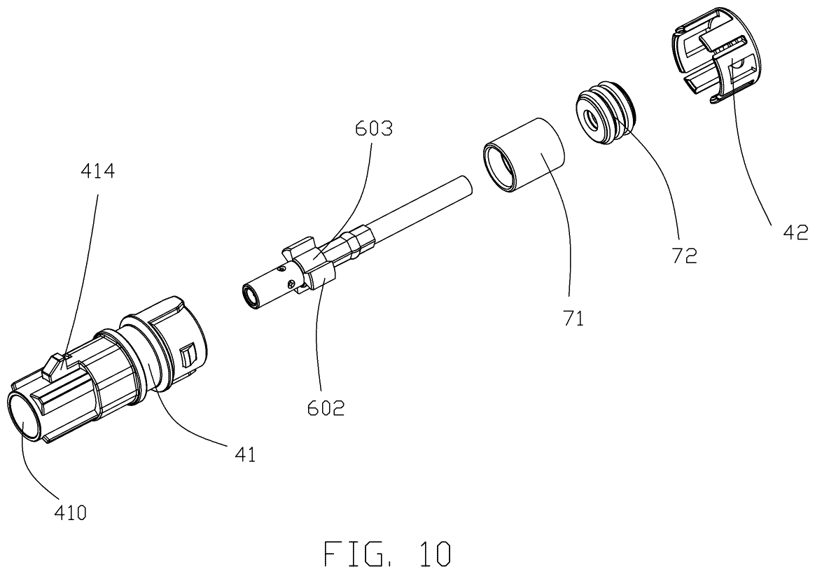

Referring to FIGS. 9-10, the shell 40 comprises a main shell 41 and a rear cover 42, the main shell 41 has a receiving cavity 410 and plural elastic arms 411 extending backward from an inner wall of the receiving cavity 410. The elastic arm 411 has a resisting portion 412, the conductive assembly 60 has a fixing member 601 and is inserted into the receiving cavity 410, the resisting portion 412 of the elastic arm 411 abuts against the fixing member 601 forwardly for preventing the conductive assembly 60 from moving backward. For reliable fixation of the conductive assembly 60, the limiting member 71 is inserted into the space between the elastic arms and the inside of the receiving cavity 410 to stop the resisting portion 412 from separating from the limiting member 71 by preventing the elastic arms 411 from deforming. Similar to the resisting portion 112, the resisting portion 412 is configured as a hook too. The fixing member 601 is fixed outside the outer conductor 63 by injection molding. The fixing member 601 has plural receiving grooves 603 along the circumferential direction, and each plural convex strip 602 is between every two receiving grooves 603. The hook of the elastic arms 411 pass through the corresponding receiving grooves 603 and resist against a rear end of the fixing member 601. The convex strips 602 protrude radially until the convex strips reach the inside of the main shell 111 to make the conductive assembly 20 stably retained in the main shell 111 along radial direction. The main shell 41 comprises a front abutting portion (not shown) in front of the fixing member 601, a front end of the fixing member 601 abuts against the front abutting portion 113 to prevent the fixing member from moving forward.

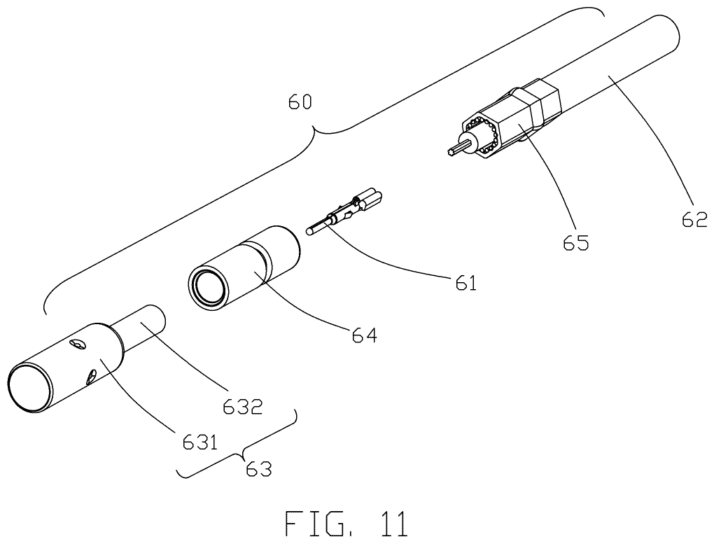

Referring to FIGS. 10-11, for reliable fixation of the conductive assembly 60, the number of the elastic arms 411 is not less than two, and the elastic arms are evenly distributed on an outer periphery of the fixing member 601 along the circumferential direction. Preferably, the number of the elastic arms is three. For better fixation of the fixing member 601 to the outer conductor 63, the outer conductor 63 comprises a front portion 631 and a rear portion 632, a front end of the cable 62 surrounds and electrically connects the rear portion 632, a diameter of the front portion 631 is larger than a diameter of the rear portion 632, the fixing member 601 is injection molded at a junction of the front portion 631 and the rear portion 632. Combining with FIG. 9, the conductive assembly 60 comprises a metal sleeve 65 which is placed outside the front end of the cable 62, a front end of the metal sleeve 65 abuts against the rear end of the fixing member 601. The mating connector 200 further comprises a rear ring 72 in the receiving cavity 410, and a front end of the rear ring 72 abuts against a rear end of the limiting member 71.

Referring to FIG. 1 and FIGS. 10-11, the mating connector 200 further comprises a locking portion which comprises a latch 414 protruding upward from an upper face of the main shell 41. The latch 414 goes into the locking hole 117 of the locking arm 115 and the pin-shaped inner conductor 61 is inserted into the mating hole of the female inner conductor 21 when the electrical connector 100 and the mating connector 200 are mated. The locking arm 115 has an operating portion 118 away from the locking hole 117 thereof. The latch 414 escapes from the locking hole 117 of the locking arm 115 when the locking arm 115 are elastically deformed by pressing the operating portion 118, and then, the electrical connector 100 and the mating connector 200 can be separated from each other. To prevent the operating portion 118 from being pressed accidently, the second locking member 116 is inserted into a space below the operating portion 118.

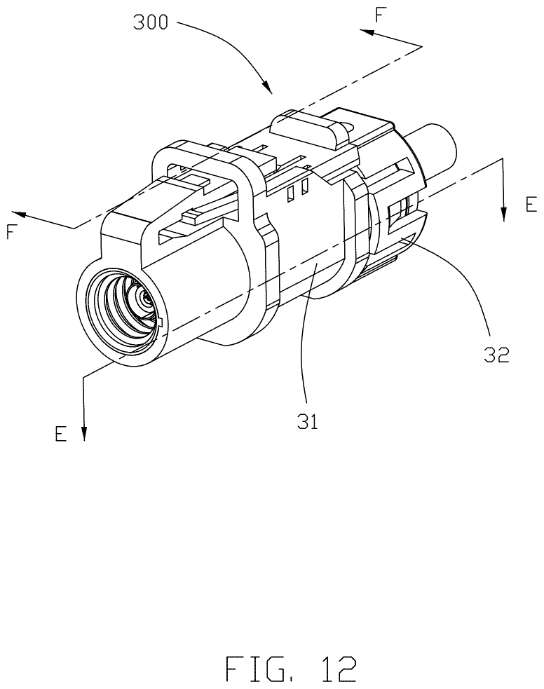

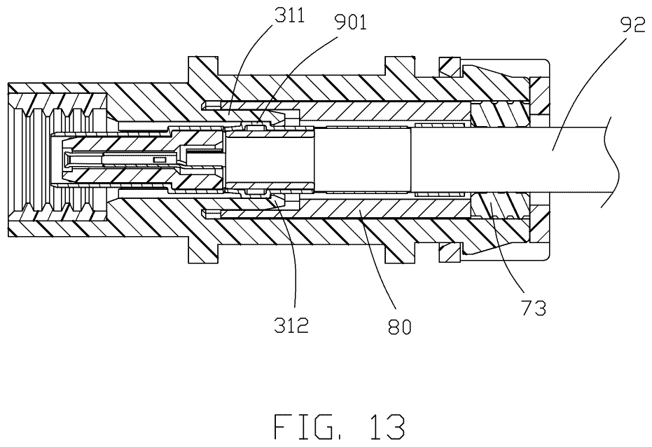

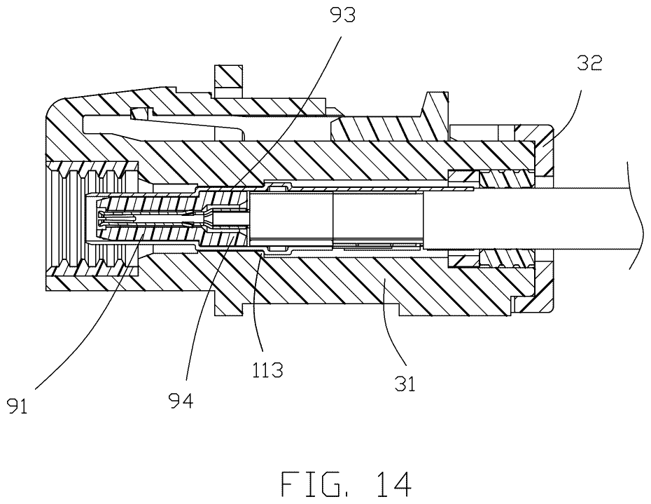

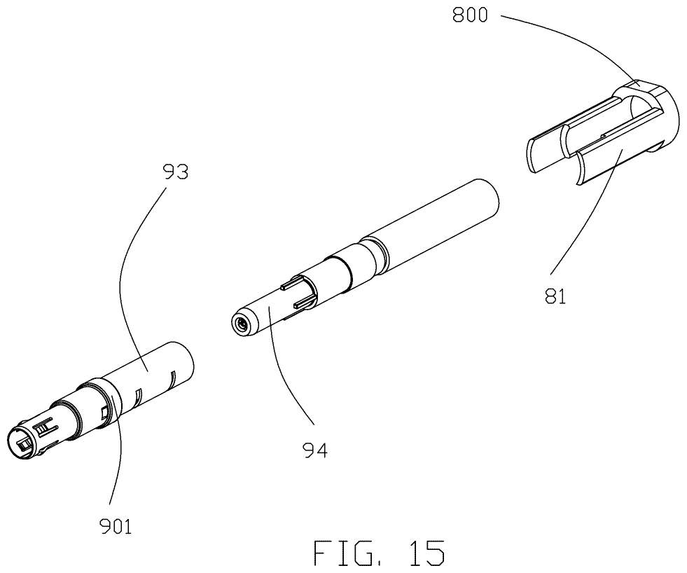

Referring to FIGS. 12-15, an electrical connector 300 of the second embodiment is illustrated, which is similar to the electrical connector 100 in the first embodiment. The electrical connector 300 comprises a main shell 31, a conductive assembly (not labeled), a rear sealing ring 73 and a rear cover 32. The conductive assembly comprises an inner conductor 91, a cable 92, an outer conductor 93 and an insulator 94 located between the inner conductor 91 and the outer conductor 93. The conductive assembly is inserted into the receiving cavity 310 from a rear end of the receiving cavity 310. The main shell 31 has a receiving cavity 310 and elastic arms 311 extending backwardly from an inside of the receiving cavity 310, the elastic arm 311 has a resisting portion 312 at a rear end thereof, the resisting portion 312 abuts against the conductive assembly forwardly to prevent the conductive assembly from moving backward.

In the first embodiment, the conductive assembly 20, 60 are injection molded with the fixing member 201, 601, and the conductive assembly 20, 60 are stopped from moving by the fixing member 201, 601. Referring to FIGS. 12-15, differing from the fixing member 201, 601 injection-molded outside the conductive assembly 20, 60 in the first embodiment, the fixing member 901 in the second embodiment is a convex ring integrally protruding from an outside of the outer conductor 93, the resisting portion 312 which is configured as a hook abuts against the convex ring forwardly. The electrical connector 300 further comprises a limiting member 80 which is inserted into a space between the elastic arms 311 and the inside of the receiving cavity 310 to stop the elastic arms from deforming. Firstly, insert the conductive assembly into the receiving cavity 310 from a rear end of the receiving cavity 310 until the hook of the elastic arms abuts against the convex strips forwardly. Secondly, make the cable go through the limiting member 80 and assemble the limiting member 80 into the receiving cavity from a rear end of the main shell 31. Thirdly, assemble the rear cover 32 to the main shell 31. Differing from the first embodiment, the main shell 31 has two elastic arms 311. The limiting member 80 has an annular main portion 800 and two inserting arms 81 extending forwardly from the main portion 800. When the limiting member 80 is assembled into the receiving cavity 310, the two inserting arms 81 are sandwiched between the elastic arms 311 and the inside of the receiving cavity to stop the elastic arms from deforming.

In the first and second embodiments, all the elastic arms 111, 311, 411 extend from the main shell 11, 31, 41 and the fixing members 201, 601, 43 are fixed with the conductive assembly 20, 60, 90. When the conductive assembly 20, 60, 90 are inserted into the main shell 11, 31, 41, the elastic arms 111, 311, 411 are stopped from deforming by the limiting members 51, 71, 80. Alternatively, the elastic arms 111, 311, 411 may extend from the conductive assembly 20, 60, 90 while the fixing member 201, 601, 43 is fixed with/or integrally formed with the main shell 11, 31, 41. For example, an injection member is injection molded outside the outer conductor 23, 63, 93, and the injection member has two or more elastic arms extending backwardly. The main shell 11, 31, 41 has a fixing member in the receiving cavity thereof, the conductive assembly 20, 60, 90 are stopped from moving backward by the elastic arms 111, 311, 411 abutted against by the fixing member. A hook is provided at a free end of the elastic arm and the fixing member is configured as a locking hole, the conductive assembly 20, 60, 90 are stopped from moving backward when the hook is latched by the locking hole. A limiting member 51, 71, 80 is also needed to be inserted into a space between the elastic arms and an outside wall of the injection member to stop the elastic arms from deforming.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
a main shell having a receiving cavity going through a front end and a rear end thereof;
a conductive assembly received in the receiving cavity and comprising an inner conductor, an outer conductor, and a cable electrically connected with the inner conductor and the outer conductor; and
a limiting member;
wherein the main shell has plural elastic arms extending rearward in the receiving cavity and each elastic arm has a hook, the conductive assembly has a fixing member radiating therearound, the hooks abut forwards against a rear face of the fixing member, and the limiting member is sandwiched between the elastic arms and an inside of the receiving cavity.

2. The electrical connector as claimed in claim 1, wherein the fixing member is injection molded around an outside of the outer conductor.

3. The electrical connector as claimed in claim 2, wherein the fixing member has plural receiving grooves, and the hooks pass through corresponding receiving grooves and the elastic arms are received in corresponding receiving grooves.

4. The electrical connector as claimed in claim 3, wherein a front end of the fixing member abuts forwards against the inside of the receiving cavity.

5. The electrical connector as claimed in claim 1, wherein the fixing member is a convex ring integrally protruding outwards from the outer conductor, and the hooks abut a rear end of the convex ring.

6. The electrical connector as claimed in claim 5, wherein a front end of the convex ring abuts against the inside of the receiving cavity.

7. The electrical connector as claimed in claim 5, wherein the limiting member is of a tube, and a front thin portion is located opposite to the hooks.

8. The electrical connector as claimed in claim 1, wherein the limiting member is at least partially inserted into a space between the elastic arms and the inside of the receiving cavity.

9. An electrical connector comprising:
an insulating shell having a receiving cavity with a front opening and a rear opening;
a conductive assembly inserted into the receiving cavity and comprising an inner conductor, a cable electrically connected to a rear end of the inner conductor, and a fixing member; and
a limiting member;
wherein the insulating shell has plural elastic arms extending rearward into the receiving cavity and each elastic arm has a hook, the hook abuts forwards against the fixing member after the conductive assembly is inserted into the receiving cavity, and the limiting member is inserted into a gap between the elastic arms and an inside of the receiving cavity to stop the elastic arms from deforming in a radiating direction of the electrical assembly.

10. The electrical connector as claimed in claim 9, wherein the fixing member is injection molded to the conductive assembly.

11. The electrical connector as claimed in claim 10, wherein the fixing member has plural convex strips protruding radially along a circumferential direction and plural receiving grooves, and each of the receiving grooves is located between every two convex strips, and the elastic arms go through corresponding receiving grooves.

12. The electrical connector as claimed in claim 11, wherein the conductive assembly comprises an outer conductor surrounding the inner conductor; and the fixing member is injection molded at an outside of the outer conductor or the fixing member is a convex ring integrally protruding from the outer conductor.

13. A method of making an electrical connector, comprising the steps of:
providing an conductive assembly to comprise an inner conductor, an outer conductor, a cable connected with the inner conductor and the outer conductor, and a fixing member around the outer conductor;
providing a main shell to have a receiving cavity and at least two elastic arms extending backward in the receiving cavity with each of the elastic arms having a resisting portion;
inserting the conductive assembly into the receiving cavity from a rear end of the main shell until the resisting portions abut against a rear end of the fixing member; and
inserting a limiting member from the rear end of the main shell into a gap between the elastic arms and an inside of the receiving cavity.

14. The method as claimed in claim 13, further comprising the steps of:
assembling a rear sealing ring through which the cable extends into the receiving cavity; and
assembling a rear cover to the rear end of the main shell.
